(19) United States
(12) Patent Application Publication
(10) Pub. No.: US 2017/0371208 A1
(43) Pub. Date: Dec. 28, 2017

(54) LIQUID CRYSTAL DISPLAY APPARATUS

(71) Applicant: SAMSUNG DISPLAY CO., LTD., YONGIN-SI (KR)

(72) Inventor: GWANGMIN CHA, YONGIN-SI (KR)

(21) Appl. No.: 15/483,042

(22) Filed: Apr. 10, 2017

(30) Foreign Application Priority Data
Jun. 24, 2016 (KR) 10-2016-0079274

(51) Int. Cl. G02F 1/1337; G02F 1/1343; G02F 1/1368

(52) U.S. Cl. CPC G02F 1/133723; G02F 1/1368; G02F 1/134309; G02F 2001/133776; G02F 2201/123; G02F 2001/133726

(57) ABSTRACT

A liquid crystal display apparatus includes a first substrate, a thin film transistor (TFT), a pixel electrode, an organic layer, a second substrate, and a liquid crystal layer. The TFT is disposed on the first substrate. The pixel electrode is electrically connected to the TFT. The pixel electrode includes side surfaces forming a first angle with respect to the first substrate. The organic layer substantially covers the side surfaces of the pixel electrode. The organic layer includes side surfaces forming a second angle with respect to the first substrate. The second angle is smaller than the first angle. The second substrate faces the first substrate. The liquid crystal layer is disposed between the first substrate and the second substrate.

### CROSS-REFERENCE TO RELATED APPLICATION

This application claims priority under 35 U.S.C. §119 to Korean Patent Application No. 10-2016-0079274, filed on Jun. 24, 2016 in the Korean Intellectual Property Office, the disclosure of which is incorporated herein by reference herein in its entirety.

### TECHNICAL FIELD

Exemplary embodiments of the present invention relate to a display apparatus, and more particularly to a liquid crystal display apparatus.

### DISCUSSION OF RELATED ART

As electronic devices such as mobile phones, personal digital assistants (PDAs), computers, and relatively large televisions (TVs) have been developed, a demand for relatively flat display apparatuses for application to these electronic devices has increased. Among relatively flat display apparatuses, liquid crystal display apparatuses may have characteristics such as relatively lower power consumption, displaying moving images relatively easily, and a relatively high contrast ratio.

A liquid crystal display apparatus may include two display panels. Electric field generation electrodes such as a pixel electrode and a common electrode may be formed on the two display panels. The liquid crystal display apparatus may include a liquid crystal layer. The liquid crystal layer may be disposed between the two display panels. The liquid crystal display apparatus may display an image by generating an electric field on the liquid crystal layer through application of a voltage to the electric field generation electrodes, determining alignment of liquid crystals of the liquid crystal layer based on the generated electric field, and controlling polarization of incident light.

### SUMMARY

According to one or more exemplary embodiments of the present invention, a pixel electrode may be arranged on a substrate. The pixel electrode may form a liquid crystal display apparatus. The pixel electrode may have a predetermined thickness. The pixel electrode may include an upper surface and side surfaces. The upper surface may be substantially parallel to the substrate. The side surfaces may form an angle with the substrate.

Alignment of liquid crystals on the pixel electrode may twist due to the angle of the side surfaces of the pixel electrode. Thus, light may leak from the side surfaces of the pixel electrode.

Dissimilar to light that is incident to the upper surface of the pixel electrode, light that is incident to the side surfaces of the pixel electrode may be refracted by a difference between refractive indices of the pixel electrode and an upper structure of the pixel electrode. Thus, light leakage may occur.

One or more exemplary embodiments of the present invention include a liquid crystal display apparatus, which may decrease or prevent light leakage by reducing an angle of the side surfaces of the pixel electrode. However, exemplary embodiments of the present invention are not limited thereto.

According to one or more exemplary embodiments of the present invention, a display apparatus may includes a first substrate, a thin film transistor (TFT), a pixel electrode, an organic layer, a second substrate, and a liquid crystal layer. The TFT is disposed on the first substrate. The pixel electrode is electrically connected to the TFT. The pixel electrode includes side surfaces forming a first angle with respect to the first substrate. The organic layer substantially covers the side surfaces of the pixel electrode. The organic layer includes side surfaces forming a second angle with respect to the first substrate. The second angle is smaller than the first angle. The second substrate faces the first substrate. The liquid crystal layer is disposed between the first substrate and the second substrate.

The first angle is about 70 degrees to about 90 degrees with respect to a main surface of the first substrate.

The organic layer may substantially cover an upper surface of the pixel electrode. The organic layer disposed on the upper surface of the pixel electrode may have a thickness of less than about 20 nm.

The liquid crystal display apparatus may include an alignment layer. The alignment layer may be disposed on the organic layer. The pixel electrode, the organic layer, and the alignment layer may each have different refractive indices.

A difference between the refractive indices of the alignment layer and the organic layer may be smaller than a difference between the refractive indices of the alignment layer and the pixel electrode.

The refractive index of the organic layer may be from about 1.5 to about 1.6.

The organic layer may include a silsesquioxane-based copolymer or a titanium oxide.

The organic layer may include a silsesquioxane-based copolymer solid and a propylene glycol monomethyl ether acetate (PGMEA) solvent.

The silsesquioxane-based copolymer solid may be less than or equal to about 5 wt % of the organic layer.

According to one or more exemplary embodiments of the present invention, a liquid crystal display apparatus may include a first substrate, a thin film transistor (TFT), a pixel electrode, an organic layer, an alignment layer, a second substrate, and a liquid crystal layer. The TFT is disposed on the first substrate. The pixel electrode is electrically connected to the TFT. The pixel electrode includes a contact portion and branches. The branches diverge from the contact portion. The pixel electrode includes side surfaces forming a first angle with respect to the first substrate. The organic layer substantially covers the side surfaces of the pixel electrode. The alignment layer is disposed on the organic layer. The second substrate faces the first substrate. The liquid crystal layer is disposed between the first substrate and the second substrate.

The first angle may be from about 70 degrees to about 90 degrees with respect to an upper surface of the first substrate.

The organic layer may include a silsesquioxane-based copolymer or a titanium oxide.

The organic layer may include a silsesquioxane-based copolymer solid and a propylene glycol monomethyl ether acetate (PGMEA) solvent.

The silsesquioxane-based copolymer solid may be equal to or greater than about 10 wt % and less than or equal to about 90 wt % of the organic layer.

The organic layer may be disposed between adjacent branches of the pixel electrode.

### BRIEF DESCRIPTION OF THE DRAWINGS

The above and other features of the present invention will become more apparent by describing in detail exemplary embodiments thereof, with reference to the accompanying drawings, in which:

FIG. 1 is a schematic plan view illustrating a liquid crystal display apparatus according to an exemplary embodiment of the present invention;

FIG. 2 is a cross-sectional view taken along a line II-II′ of FIG. 1 according to an exemplary embodiment of the present invention;

FIG. 3 is an enlarged cross-sectional view illustrating a portion A of FIG. 2 according to an exemplary embodiment of the present invention; and

FIG. 4 is an enlarged cross-sectional view illustrating a portion A of FIG. 2 according to an exemplary embodiment of the present invention.

### DETAILED DESCRIPTION OF THE EMBODIMENTS

Exemplary embodiments of the present invention will be described below in more detail with reference to the accompanying drawings. In this regard, the exemplary embodiments may have different forms and should not be construed as being limited to the exemplary embodiments of the present invention described herein.

Like reference numerals may refer to like elements throughout the specification and drawings.

It will be understood that although the terms “first” and “second” may be used herein to describe various components, these components should not be limited by these terms.

Sizes of elements in the drawings may be exaggerated for clarity of description.

It will be understood that when a component, such as a layer, a film, a region, or a plate, is referred to as being “on” another component, the component can be directly on the other component or intervening components may be present.

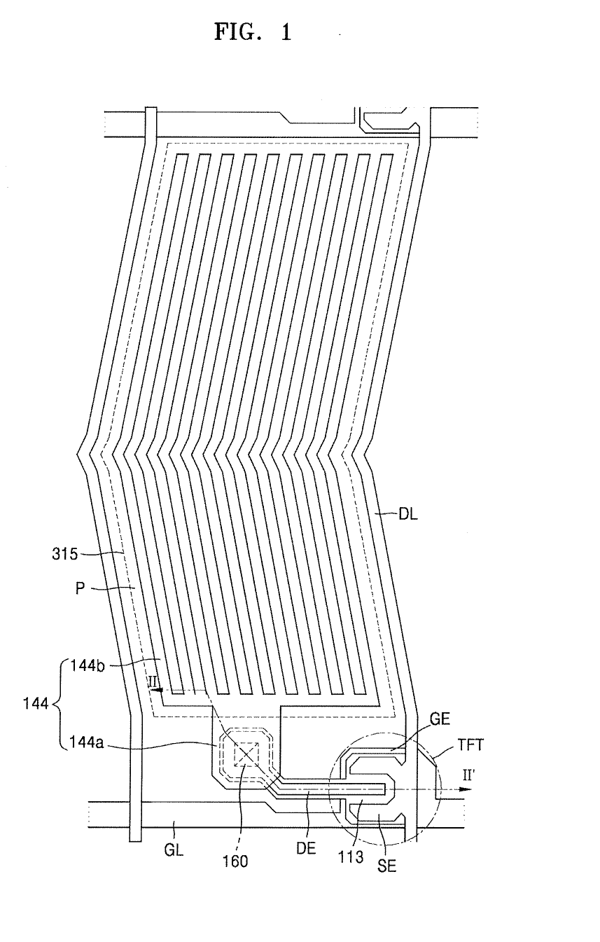

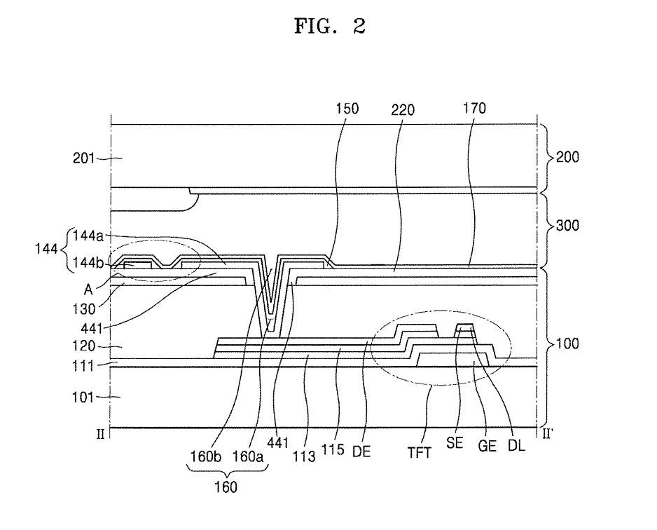

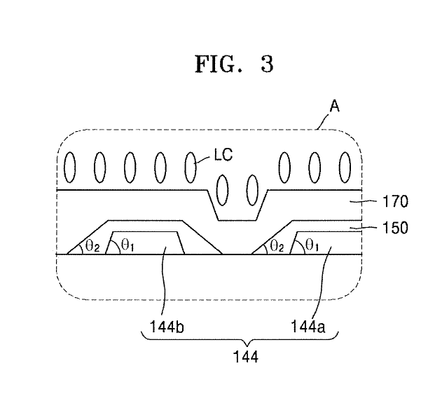

FIG. 1 is a schematic plan view illustrating a liquid crystal display apparatus according to an exemplary embodiment of the present invention. FIG. 2 is a cross-sectional view taken along a line II-II′ of FIG. 1 according to an exemplary embodiment of the present invention. FIG. 3 is an enlarged cross-sectional view illustrating a portion A of FIG. 2 according to an exemplary embodiment of the present invention.

Referring to FIGS. 1 to 3, a liquid crystal display apparatus may include a lower panel 100, a thin film transistor TFT, a pixel electrode 144 that is electrically connected to the thin film transistor TFT, an organic layer 150, an upper panel 200, and a liquid crystal layer 300. The thin film transistor TFT may be disposed in the lower panel 110. The pixel electrode 144 may be electrically connected to the thin film transistor TFT. The pixel electrode 144 may have side surfaces forming a first angle θ1 with respect to the lower panel 100. The organic layer 150 may substantially cover the side surfaces of the pixel electrode 144. The organic layer 150 may have side surfaces forming a second angle θ2 with respect to the lower panel 100. The second angle θ2 may be smaller than the first angle θ1. The upper panel 200 may face the lower panel 100. The liquid crystal layer 300 may be disposed between the lower panel 100 and the upper panel 200.

The lower panel 100 will be described in more detail below.

Referring to FIGS. 1 and 2, the lower panel 100 may include a lower substrate 101, a gate line GL, a gate electrode GE, a gate insulating layer 111, a semiconductor layer 113, an ohmic contact layer 115, a source electrode SE, a drain electrode DE, the thin film transistor TFT, a data line DL, a first protection layer 120, a common electrode 130, a second protection layer 220, the pixel electrode 144, the organic layer 150, and an alignment layer 170.

The lower substrate 101 may be an insulating substrate. The lower substrate 101 may include transparent glass or plastics.

The gate line GL and the gate electrode GE may each be disposed on the lower substrate 101.

The gate line GL may include a contact portion (e.g., an end portion). The contact portion may have a greater area than other portions of the gate line GL, which may connect the gate line GL to another layer or an external driving circuit. The gate line GL may include an aluminum (Al)-based metal such as Al or an Al alloy, a silver (Ag)-based metal such as Ag or an Ag alloy, a copper (Cu)-based metal such as Cu or a Cu alloy, or a molybdenum (Mo)-based metal such as Mo or an Mo alloy. Alternatively, the gate line GL may include chromium (Cr), tantalum (Ta), or titanium (Ti). The gate line GL may have a multi-layered structure. The multi-layered structure may include at least two conductive layers having different physical properties from each other.

Referring to FIG. 1, the gate electrode GE may separate from the gate line GL. The gate electrode GE may protrude in a direction toward a pixel area P. The gate electrode GE may include substantially the same material as the gate line GL. The gate electrode GE may have substantially the same structure (e.g., a multi-layered structure) as the gate line GL. Thus, the gate electrode GE and the gate line GL may be substantially simultaneously formed through the same processes.

The gate insulating layer 111 may be disposed on each of the gate electrode GE and the gate line GL. The gate insulating layer 111 may extend over each of the lower substrate 101, the gate electrode GE, and the gate line GL. The gate insulating layer 111 may extend over substantially the entire lower substrate 101. The gate insulating layer 111 may include silicon nitride (SiNx) or silicon oxide (SiO₂). The gate insulating layer 111 may have a multi-layered structure. The multi-layered structure may include at least two insulating layers having different physical properties from each other.

The semiconductor layer 113 may be disposed on the gate insulating layer 111. The semiconductor layer 113 may overlap at least a portion of the gate electrode GE. The semiconductor layer 113 may include amorphous silicon (a-Si) or polycrystalline silicon (poly-Si).

The ohmic contact layer 115 may be disposed on the semiconductor layer 113. The ohmic contact layer 115 may include n+ hydrogenated amorphous silicon. The n+ hydrogenated amorphous silicon may be doped with relatively high-concentration of n-type impurities such as phosphorus (P) or silicide. A pair of ohmic contact layers 115 may be disposed on the semiconductor layer 113.

The source electrode SE and the drain electrode DE may each be disposed on the ohmic contact layer 115.

Referring to FIG. 1, the source electrode SE may diverge from the data line DL. The source electrode SE may protrude in a direction toward the gate electrode GE. The source electrode SE may have an inverse C shape; however, exemplary embodiments of the present invention are not limited thereto. The inverse C shape may partially surround a portion of the drain electrode DE. At least a portion of the source electrode SE may overlap each of the semiconductor layer 113 and the gate electrode GE. The source electrode SE may have a C shape, a U shape, or an inverse U shape.

The source electrode SE may include various metals or conductors. For example, the source electrode SE may include a refractory metal such as Mo, Cr, Ta, Ti, or an alloy thereof. The source electrode SE may have a multi-layered structure. The multi-layered structure may include a refractory metal layer and a relatively low-resistance conductive layer. Examples of the multi-layered structure may be a bi-layered structure or a tri-layered structure. The bi-layered structure may include a lower layer and an upper layer. The lower layer may include Cr, Mo, or an Mo alloy. The upper layer may include Al or an Al alloy. The tri-layered structure may include a lower layer, an intermediate layer, and an upper layer. The lower layer may include Mo or an Mo alloy. The intermediate layer may include Al or an Al alloy. The upper layer may include Mo or an Mo alloy.

A first side of the drain electrode DE may be connected to the pixel electrode 144. At least a portion of a second side of the drain electrode DE may overlap each of the semiconductor layer 113 and the gate electrode GE. The drain electrode DE may include substantially the same material as the source electrode SE. The drain electrode may have substantially the same structure (e.g., a multi-layered structure) as the source electrode SE. Thus, the drain electrode DE and the source electrode SE may be substantially simultaneously formed through the same processes.

The gate electrode GE, the source electrode SE, and the drain electrode DE may form the thin film transistor TFT together with the semiconductor layer 113. A channel of the thin film transistor TFT may be disposed on a portion of the semiconductor layer 113 which is disposed between the source electrode SE and the drain electrode DE.

The data line DL may be disposed on the gate insulating layer 111. The data line DL may include a contact portion (e.g., an end portion). The contact portion may have a greater area than other portions of the data line DL, which may be configured to connect the data line DL to another layer or the external driving circuit.

The data line DL may transmit data signals. The data line DL may extend in a substantially vertical direction. Thus, the data line DL may cross the gate line GL. To obtain a highest transmissivity of the liquid crystal display apparatus, a middle portion of the data line DL may be bent, for example, in a V form. The data line DL may include the same material as the source electrode SE. The data line DL may have substantially the same structure (e.g., a multilayer structure) as the source electrode SE. Thus, the data line DL and the source electrode SE may be substantially simultaneously formed through the same processes.

The first protection layer 120 may be disposed on each of the data line DL, the source electrode SE, and the drain electrode DE. The first protection layer 120 may be positioned above the lower substrate 101. For example, the first protection layer 120 may be positioned above the entire lower substrate 101. The first protection layer 120 may be disposed on each of the data line DL, the source electrode SE, and the drain electrode DE. The first protection layer 120 may include an inorganic insulating material such as SiNx or SiO₂. The first protection layer 120 may include an inorganic insulating material. The inorganic insulating material may have a photosensitivity and a dielectric constant of about 4.0. The first protection layer 120 may have a bi-layered structure. The bi-layered structure may include a lower inorganic layer and an upper organic layer. The bi-layered structure of the first protection layer 120 may maintain insulating properties of an organic layer and reduce or prevent damage to an exposed portion of the semiconductor layer 113. A thickness of the first protection layer 120 may be equal to or greater than about 5,000 Å. Alternatively, the thickness of the first protection layer 120 may be from about 6,000 Å to about 8,000 Å.

A lower contact hole 160a may be formed in the first protection layer 120. The lower contact hole 160a may penetrate a portion of the first protection layer 120. A portion of the drain electrode DE may be exposed through the lower contact hole 160a.

The common electrode 130 may be disposed on the first protection layer 120. The common electrode 130 may substantially cover the lower substrate 101. For example, the common electrode 130 may substantially cover the entire lower substrate 101. The common electrode 130 may be disposed on each of the first protection layer 120 and the entire bottom substrate 101. Referring to FIG. 2, an opening may be formed in the common electrode 130. The opening may penetrate a portion of the common electrode 130. The opening may be positioned above the lower contact hole 160a. The opening may have a size that is large enough to surround each of the lower contact hole 160a and an upper contact hole 160b. The upper contact hole 160b will be described in more detail below. A portion of the drain electrode DE may be exposed through each of the opening and the lower contact hole 160a. The common electrode 130 may include a material included in the gate line GL or the data line DL.

The liquid crystal display apparatus according to an exemplary embodiment of the present invention may include the common electrode 130. The common electrode 130 may be positioned above the upper panel 200. The liquid crystal layer 300 may be disposed between the pixel electrode 144 and the common electrode 130.

The second protection layer 220 may be disposed on the common electrode 130. The second protection layer 220 may substantially cover the lower substrate 101. For example, the second protection layer 220 may substantially cover the entire lower substrate 101. The second protection layer 220 may be on each of the lower substrate 101 and the common electrode 130. The second protection layer 220 may include a same material as the material included in the first protection layer 120.

The upper contact hole 160b may penetrate a portion of the second protection layer 220. The upper contact hole 160b may be formed in the second protection layer 220. The upper contact hole 160b may be positioned above the opening formed in the common electrode 130. The lower contact hole 160a and the upper contact hole 160b may be connected to each other, for example, through the opening in the common electrode 130. Thus, a drain contact hole 160 may be formed.

The drain contact hole 160 may be formed through the following exemplary processes described in more detail below. After the common electrode 130 is disposed on the first protection layer 120, a portion of the common electrode 130 may be removed, for example, through photolithography and an etching process. Thus, the opening of the common electrode 130 may be formed. The first protection layer 120 may be exposed through the opening. The second protection layer 220 may be formed above each of the bottom substrate 101 and the common electrode 130 in which the opening is formed. A portion of the second protection layer 220 may contact a portion of the first protection layer 120 that is exposed through the opening. A portion of the second protection layer 220 and the portion of the first protection layer 120 which correspond to the opening may be removed, for example, through a photolithography and an etching process. The drain contact hole 160 may be formed. The photolithography and the etching process may be performed so that the drain contact hole 160 is surrounded by the opening and the exposed portion of the common electrode 130 corresponding to an inner wall of the opening is covered by the second protection layer 220. Thus, a short circuit between the common electrode 130 and the pixel electrode 144 inserted into the drain contact hole 160 may be reduced or prevented.

The pixel electrode 144 may produce a horizontal electric field along with the common electrode 130. The pixel electrode 144 may include a contact portion 144a and branches 144b. The branches 144b may diverge from the contact portion 144a. The contact portion 144a on the drain contact hole 160 may be connected to the drain electrode DE exposed through the drain contact hole 160. The branches 144b may be disposed in the pixel area P. The horizontal electric field may be produced between the branches 144b and the common electrode 130. The branches 144b may be linear electrodes. The common electrode 130 may be a planar electrode. The branches 144b may extend in a direction that is substantially the same as a direction in which the data line DL extends. Middle portions of the branches 144b may be bent, for example, in a V shape. The branches 144b may extend in a direction toward the outside of the pixel area P.

The pixel electrode 144 according to an exemplary embodiment of the present invention may include the contact portion 144a and the branches 144b. The contact portion 144a may have a cross shape. The branches 144b may diverge from the contact portion 144a. The branches 144b may diverge in four directions. For example, the branches 144b may diverge in an upper left direction, an upper right direction, a lower left direction, and a lower right direction.

The pixel electrode 144 may include side surfaces. The side surfaces may have the first angle θ1 with respect to the lower panel 100. The first angle θ1 may range from about 70 degrees to about 90 degrees with respect to a main surface of the lower panel 100. As the first angle θ1 increases, inclined side surfaces of the pixel electrode 144 may decrease. As an amount of light that is incident onto the inclined surfaces of the pixel electrode 144 decreases, light leaking from the liquid crystal display apparatus may decrease.

The pixel electrode 144 may include a transparent conductive material such as indium tin oxide (ITO) or indium zinc oxide (IZO). A refractive index of the pixel electrode 144 may be from about 1.9 to about 2.0. For example, the refractive index of the pixel electrode 144 including ITO may be about 1.9. The refractive index of the pixel electrode 144 including IZO may be about 2.0.

Referring to FIG. 2, since a portion 441 of the second protection layer 220 is disposed between the pixel electrode 144 and the exposed portion of the common electrode 130 which forms the inner wall of the opening, a short circuit between the pixel electrode 144 and the common electrode 130 may be reduced or prevented.

The organic layer 150 may be disposed on the pixel electrode 144. The organic layer 150 may substantially cover the upper surface and the side surfaces of the pixel electrode 144. The organic layer 150 may have the side surfaces forming the second angle θ2 with respect to the lower panel 100. The second angle θ2 may be smaller than the first angle θ1.

The organic layer 150 may include a silsesquioxane-based copolymer and/or a titanium oxide. For example, the organic layer 150 may include a silsesquioxane-based copolymer solid and a propylene glycol monomethyl ether acetate (PGMEA) solvent. A refractive index of the organic layer 150 may be from about 1.5 to about 1.6. For example, the refractive index of the organic layer 150 including the silsesquioxane-based copolymer may be about 1.5. The refractive index of the organic layer 150 including titanium oxide may be about 1.6.

Depending on a composition of a solid included in the organic layer 150, the second angle θ2 and a thickness of the organic layer 150 covering the upper surface of the pixel electrode 144 may differ. According to an exemplary embodiment of the present invention, side surfaces of the organic layer 150 may have the second angle θ2, for example, a gradient of less than about 70 degrees. Thus, the second angle θ2 of the organic layer 150 may be smaller than the first angle θ1 of the pixel electrode 144. The organic layer 150 may include a silsesquioxane-based copolymer solid. The silsesquioxane-based copolymer solid may be in an amount less than or equal to about 5 wt % based on the organic layer 150. A thickness of the organic layer 150 on the upper surface of the pixel electrode 144 may be less than or equal to about 20 nm.

According to an exemplary embodiment of the present invention, a gradient of the side surfaces of the pixel electrode 144 may decrease due to the organic layer 150. Thus, an alignment direction of liquid crystals LCs of the liquid crystal layer 300 on the upper surface of the pixel electrode 144 might not be twisted. Light leakage resulting from the twisting of the alignment direction of the liquid crystals LCs of the liquid crystal layer 300 may be reduced or prevented. A contrast ratio of the liquid crystal display apparatus may be increased.

The alignment layer 170 may be positioned above each of the pixel electrode 144 and the organic layer 150. The alignment layer 170 may be a vertical alignment layer. The alignment layer 170 may include a material such as polyimide, a polyamic acid or polysiloxane. The refractive index of the alignment layer 170 may be about 1.7.

The pixel electrode 144, the organic layer 150, and the alignment layer 170 may each have different refractive indices. If the organic layer 150 is not formed and the side surfaces of the pixel electrode 144 have the second angle θ2 instead of the first angle θ1, light that is incident to the inclined side surfaces of the pixel electrode 144 may be refracted due to a difference between the refractive indices of the pixel electrode 144 and the alignment layer 170.

According to an exemplary embodiment of the present invention, a difference between the refractive indices of the organic layer 150 and the alignment layer 170 may be smaller than the difference between the refractive indices of the pixel electrode 144 and the alignment layer 170. Due to the difference between the refractive indices of the organic layer 150 and the alignment layer 170, light that is incident to the organic layer 150 may be less refracted than light that is incident to the inclined side surfaces of the pixel electrode 144 which have the second angle θ2. Due to the organic layer 150 according to an exemplary embodiment of the present invention, the difference between the indices of structures of the liquid crystal display apparatus, for example, structures through which light passes decreases. Thus, the light leakage of the liquid crystal display apparatus may be reduced or prevented.

The upper panel 200 will be described in more detail below.

Referring to FIGS. 1 and 2, the upper panel 200 may include a black matrix 315 and color filters. The upper panel 200 may include an overcoat layer. The overcoat layer may be formed on each of an upper substrate 201 and the color filters. The overcoat layer may be formed substantially on the entire upper substrate 201.

The upper substrate 201 may be an insulating substrate. The upper substrate 201 may include transparent glass or plastic.

The black matrix 315 may be disposed on the upper substrate 201. The black matrix 315 may block light, for example, that may leak from portions other than the pixel area P. The portions other than the pixel area P may include, for example, a disclination area where the liquid crystals LCs are not controlled by an abnormal vertical electric field.

The liquid crystal display apparatus according to an exemplary embodiment of the present invention may include the black matrix 315 disposed on the lower panel 100 and/or the color filters.

According to an exemplary embodiment of the present invention, the color filters may include a red color filter, a green color filter, and a blue color filter. The color filters may be positioned at locations corresponding to portions of the upper substrate 201, for example, the pixel areas P. The pixel areas P might not be covered by the black matrix 315. Portions of edges of the color filters may be disposed on the black matrix 315.

A polarizer may be disposed on an outer surface of each of the lower panel 100 and the upper panel 200. Transmission axes of the polarizers may be substantially orthogonal to each other. One of the transmission axes may be substantially parallel to the gate line GL. The polarizer may be disposed on an outer surface of the lower panel 100 or the upper panel 200. The liquid crystal layer 300 may have negative dielectric anisotropy. The liquid crystals LCs of the liquid crystal layer 300 may be aligned so that a long axis of the liquid crystals LCs is substantially perpendicular to each of the surfaces of the lower panel 100 and the upper panel 200 with no electric field. Therefore, while there is no electric field, incident light might not pass through an orthogonal polarizer. Thus, the incident light may be blocked. Alternatively, the liquid crystal layer 300 may have positive dielectric anisotropy. The liquid crystals LCs may be aligned substantially parallel to each of the surfaces of the lower panel 100 and the upper panel 200.

At least one of the liquid crystal layer 300 and the alignment layer 170 may include a light reactive substance, for example, reactive mesogen.

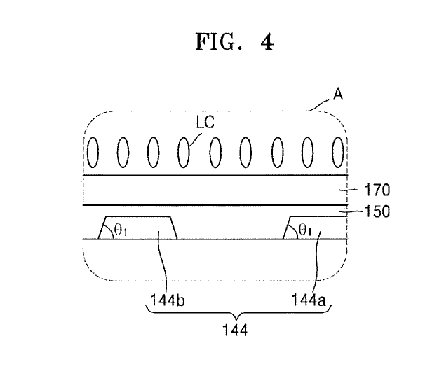

FIG. 4 is an enlarged cross-sectional view illustrating a portion A of FIG. 2 according to an exemplary embodiment of the present invention.

Referring to FIGS. 1, 2, and 4, the liquid crystal display apparatus according to an exemplary embodiment of the present invention may include the lower panel 100. The thin film transistor TFT may be disposed on the lower panel 100. The liquid crystal display apparatus may include the pixel electrode 144. The pixel electrode 144 may be electrically connected to the thin film transistor TFT. The pixel electrode 144 may include the contact portion 144a and the branches 144b. The branches 144b may diverge from the contact portion 144a. The pixel electrode 144 may have the side surfaces having the first angle θ1 with respect to the lower panel 100. The liquid crystal display apparatus may include the organic layer 150. The organic layer 150 may substantially cover each of the upper surface and the side surfaces of the pixel electrode 144. The liquid crystal display apparatus may include the alignment layer 170. The alignment layer 170 may be disposed on the organic layer 150. The liquid crystal display apparatus may include the upper panel 200. The upper panel 200 may face the lower panel 100. The liquid crystal display apparatus may include the liquid crystal layer 300. The liquid crystal layer 300 may be disposed between the lower panel 100 and the upper panel 200.

The first angle θ1 may be equal to or greater than about 70 degrees, but less than or equal to about 90 degrees with respect to the main surface of the lower panel 100.

The organic layer 150 may include a silsesquioxane-based copolymer and/or titanium oxide. For example, the organic layer 150 may include silsesquioxane-based copolymer solid and a PGMEA solvent. A weight percent of the silsesquioxane-based copolymer solid included in the organic layer 150 may be equal to or greater than about 10 wt % and less than or equal to about 90 wt %. The organic layer 150 may be disposed between adjacent branches 144b of the pixel electrode 144. An upper surface of the organic layer 150 may be substantially parallel to an upper surface of the lower panel 100.

According to an exemplary embodiment of the present invention, as a gradient of the side surfaces of the pixel electrode 144 decreases due to the organic layer 150, the alignment direction of the liquid crystals LCs of the liquid crystal layer 300 which are disposed on the pixel electrode 144 might not twist such that light leakage of the liquid crystal display apparatus may be reduced or prevented. Additionally, a contrast ratio may be increased.

Since the difference between the refractive indices of the organic layer 150 and the alignment layer 170 may be relatively small, light passing through the organic layer 150 and the alignment layer 170 may be slightly refracted. Thus, light leakage of the liquid crystal display apparatus may be reduced or prevented.

According to the one or more exemplary embodiments of the present invention, a gradient of side surfaces of a pixel electrode forming a liquid crystal display apparatus may decrease. An alignment direction on liquid crystals LCs on the pixel electrode might not twist. Thus, light leakage of the liquid crystal display apparatus may be reduced or prevented.

According to the one or more exemplary embodiments of the present invention, the light leakage of the liquid crystal display apparatus may be reduced or prevented by reducing a difference between refractive indices between an upper structure of the pixel electrode and the pixel electrode forming the liquid crystal display apparatus.

According to the one or more exemplary embodiments of the present invention, since an amount of light that is incident to the side surfaces of the pixel electrode may decrease by reducing an area of the side surfaces of the pixel electrode forming the liquid crystal display apparatus, light leakage of the liquid crystal display apparatus may be reduced or prevented.

It should be understood that exemplary embodiments of the present invention described herein should be considered in a descriptive sense only and not for purposes of limitation. Descriptions of features or aspects within each exemplary embodiment should be considered as available for other similar features or aspects in other exemplary embodiments.

While one or more exemplary embodiments of the present invention have been described with reference to the figures, it will be understood by those of ordinary skill in the art that various changes in form and details may be made therein without departing from the spirit and scope of the present invention.

What is claimed is:

1. A display apparatus, comprising:
a first substrate;
a thin film transistor (TFT) disposed on the first substrate;
a pixel electrode electrically connected to the TFT and having side surfaces forming a first angle with respect to the first substrate;
an organic layer substantially covering the side surfaces of the pixel electrode and having side surfaces forming a second angle with respect to the first substrate, the second angle being smaller than the first angle;
a second substrate facing the first substrate; and
a liquid crystal layer disposed between the first substrate and the second substrate.

2. The display apparatus of claim 1, wherein the first angle is about 70 degrees to about 90 degrees with respect to a main surface of the first substrate.

3. The display apparatus of claim 1, wherein the organic layer substantially covers an upper surface of the pixel electrode, and
the organic layer disposed on the upper surface of the pixel electrode has a thickness of less than about 20 nm.

4. The display apparatus of claim 1, further comprising an alignment layer disposed on the organic layer,
wherein the pixel electrode, the organic layer, and the alignment layer each have different refractive indices.

5. The display apparatus of claim 4, wherein a difference between the refractive indices of the alignment layer and the organic layer is smaller than a difference between the refractive indices of the alignment layer and the pixel electrode.

6. The display apparatus of claim 4, wherein the refractive index of the organic layer is from about 1.5 to about 1.6.

7. The display apparatus of claim 4, wherein the organic layer comprises a silsesquioxane-based copolymer or a titanium oxide.

8. The display apparatus of claim 4, wherein the organic layer comprises a silsesquioxane-based copolymer solid and a propylene glycol monomethyl ether acetate (PGMEA) solvent.

9. The display apparatus of claim 8, wherein the silsesquioxane-based copolymer solid is less than or equal to about 5 wt % of the organic layer.

10. A display apparatus comprising:
a first substrate;
a thin film transistor (TFT) disposed on the first substrate;
a pixel electrode electrically connected to the TFT, comprising a contact portion and branches diverging from the contact portion, and having side surfaces forming a first angle with respect to the first substrate;
an organic layer substantially covering the side surfaces of the pixel electrode;
an alignment layer disposed on the organic layer;
a second substrate facing the first substrate; and
a liquid crystal layer disposed between the first substrate and the second substrate.

11. The display apparatus of claim 10, wherein the first angle is from about 70 degrees to about 90 degrees with respect to an upper surface of the first substrate.

12. The display apparatus of claim 10, wherein the organic layer comprises a silsesquioxane-based copolymer or a titanium oxide.

13. The display apparatus of claim 10, wherein the organic layer comprises a silsesquioxane-based copolymer solid and a propylene glycol monomethyl ether acetate (PGMEA) solvent.

14. The display apparatus of claim 13, wherein the silsesquioxane-based copolymer solid is equal to or greater than about 10 wt % and less than or equal to about 90 wt % of the organic layer.

15. The display apparatus of claim 10, wherein the organic layer is disposed between adjacent branches of the pixel electrode.

16. The display apparatus of claim 10, wherein the contact portion has a cross shape, and the branches diverge from the contact portion in different directions.

17. The display apparatus of claim 10, wherein the branches of the pixel electrode are linear electrodes.

18. The display apparatus of claim 10, wherein the organic layer covers substantially an upper surface of the pixel electrode, and
the organic layer disposed on the upper surface of the pixel electrode has a thickness of less than about 20 nm.

19. A display apparatus, comprising:
a first substrate;
a thin film transistor (TFT) disposed on the first substrate;
a pixel electrode having side surfaces forming a first angle with respect to the first substrate;
an organic layer having side surfaces forming a second angle with respect to the first substrate, the second angle being smaller than the first angle;
a second substrate facing the first substrate; and
a liquid crystal layer disposed between the first substrate and the second substrate.
